(19) United States
(12) Patent Application Publication
(10) Pub. No.: US 2022/0136806 A1
(43) Pub. Date: May 5, 2022

(54) Projectile Trapping Device

(71) Applicant: Daniel De Jesus, Rio Grande, PR (US)

(72) Inventor: Daniel De Jesus, Rio Grande, PR (US)

(21) Appl. No.: 17/087,213

(22) Filed: Nov. 2, 2020

(51) Int. Cl. F41H 5/24; A01D 34/00

(52) U.S. Cl. CPC F41H 5/24; A01D 34/001

(57) ABSTRACT

A projectile trapping device for protecting objects from impact damage includes a shell, which defines an interior space. The shell has a front face, which is open. The shell can be positioned on a substantially horizontal surface between an object, such as a vehicle, a person, or glass, and a source of projectiles, such as a lawnmower, an edger, or a trimmer. The shell prevents projectiles propelled from the source from striking the object.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trapping devices and more particularly pertains to a new trapping device for protecting objects from impact damage.

### (2) Description of Related Art Including Information Disclosed Under 37 CFR 1.97 and 1.98

The prior art relates to trapping devices, in particular trapping devices to prevent projectiles launched by trimmers and mowers. The prior art does not provide for the base features of the current invention.

### BRIEF SUMMARY OF THE INVENTION

An embodiment of the disclosure meets the needs presented above by generally comprising a shell, which defines an interior space. The shell has a front face, which is open. The shell is configured to position on a substantially horizontal surface between an object, such as a vehicle, a person, or glass, and a source of projectiles, such as a lawnmower, an edger, or a trimmer. The shell is configured to prevent projectiles propelled from the source from striking the object.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a projectile trapping device according to an embodiment of the disclosure.

FIG. 2 is a front view of an embodiment of the disclosure.

FIG. 3 is a side view of an embodiment of the disclosure.

FIG. 4 is an in-use view of an embodiment of the disclosure.

FIG. 5 is a detail isometric perspective view of an embodiment of the disclosure.

FIG. 6 is an isometric perspective view of an alternative embodiment of the disclosure.

FIG. 7 is a front view of an alternative embodiment of the disclosure.

FIG. 8 is a side view of an alternative embodiment of the disclosure.

FIG. 9 is an in-use view of an alternative embodiment of the disclosure.

FIG. 10 is a detail isometric perspective view of an alternative embodiment of the disclosure.

### DETAILED DESCRIPTION OF THE INVENTION

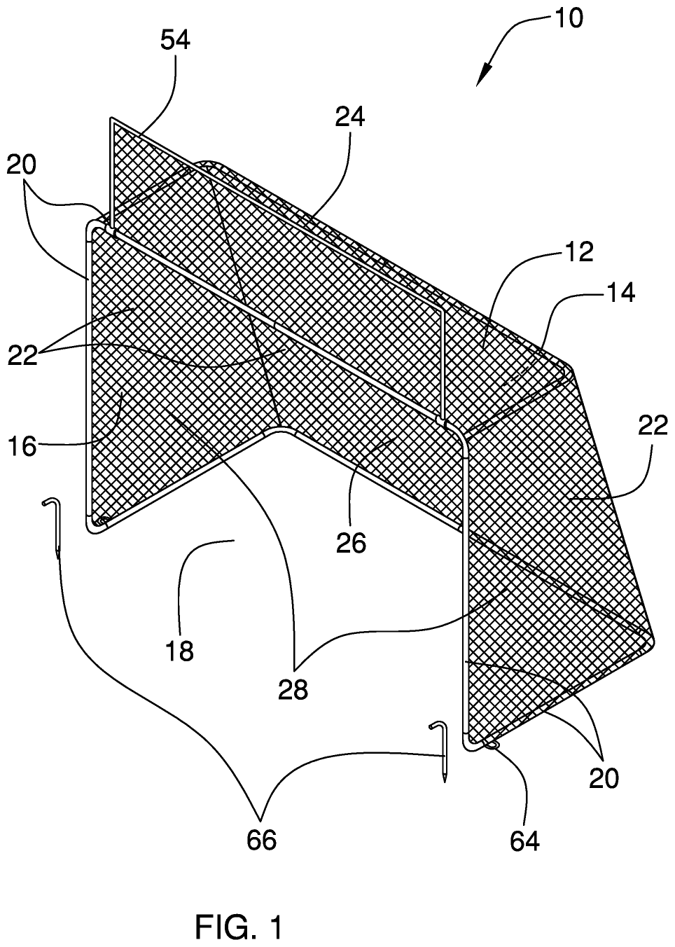

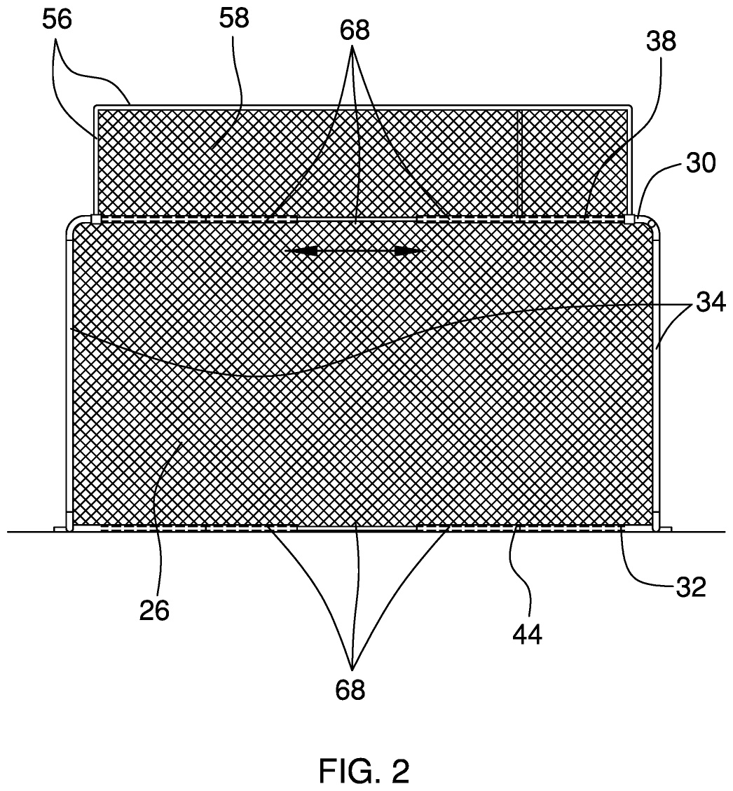

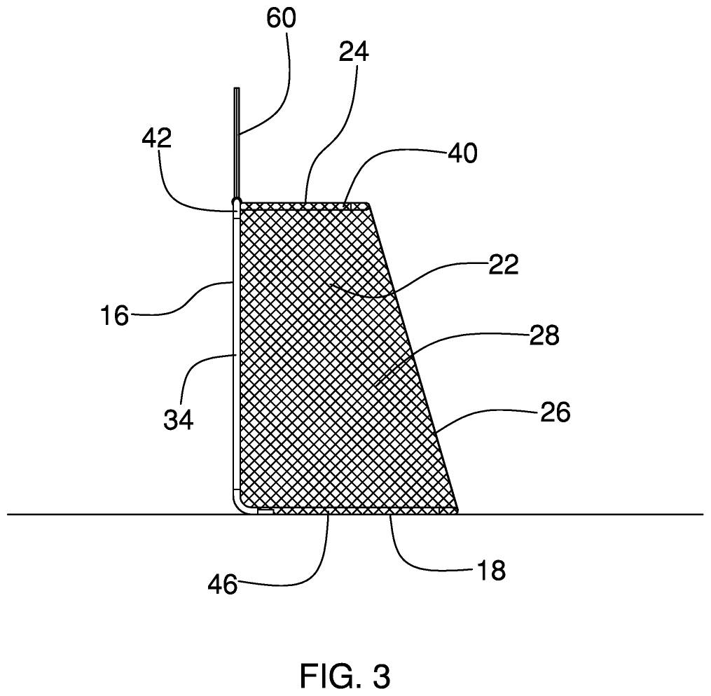

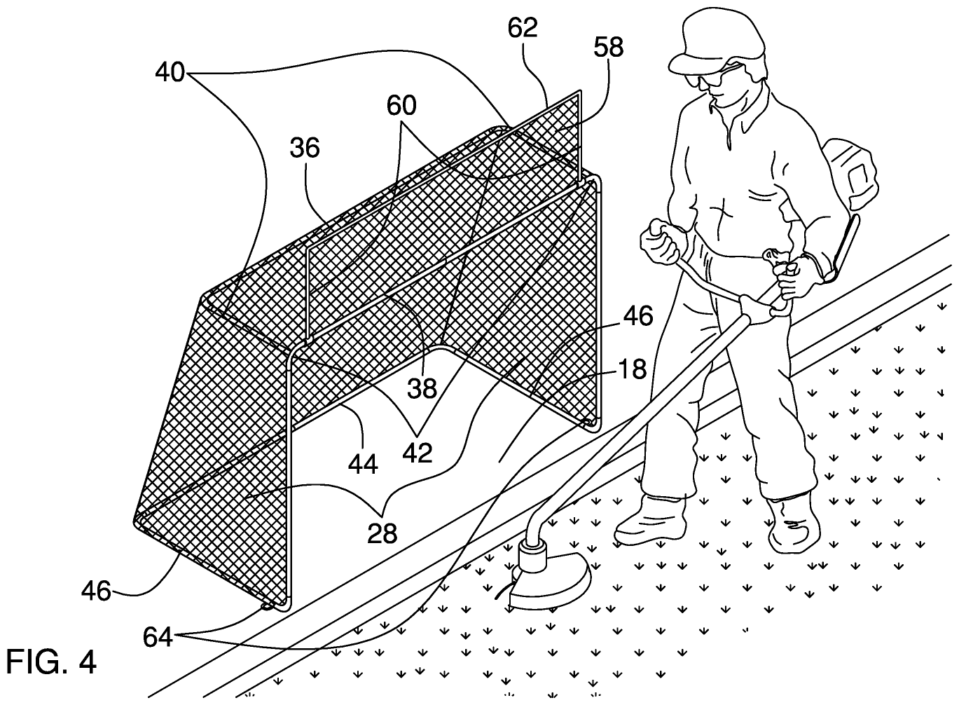

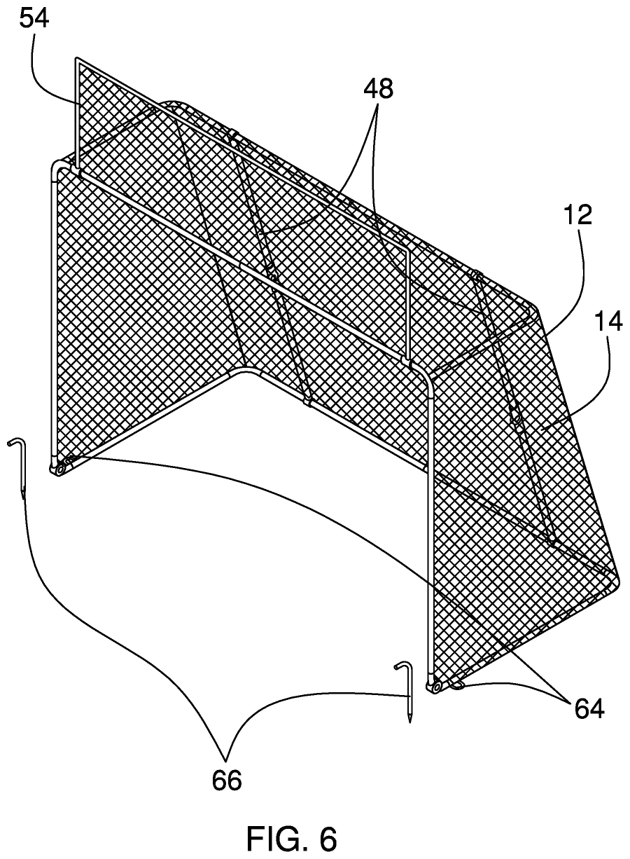

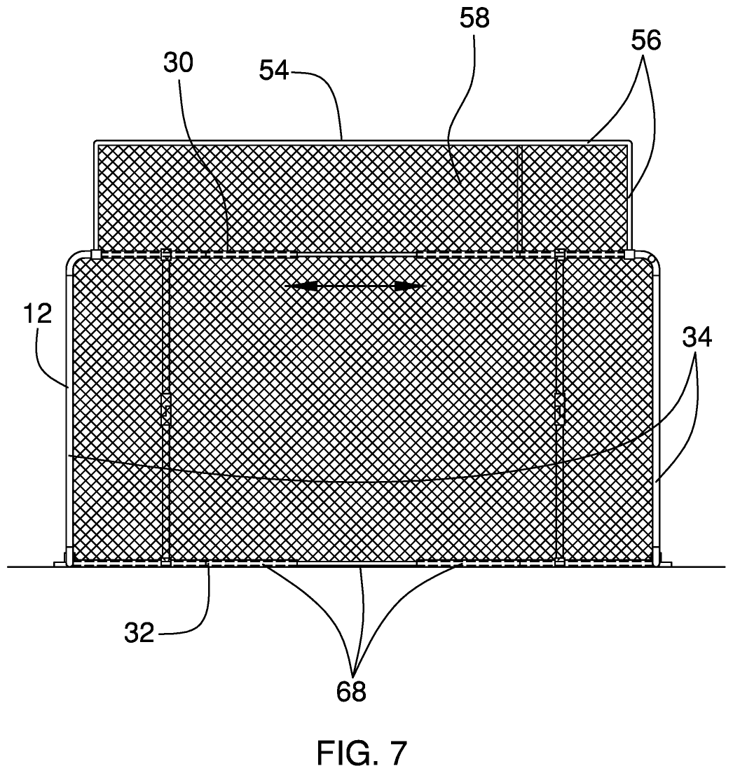

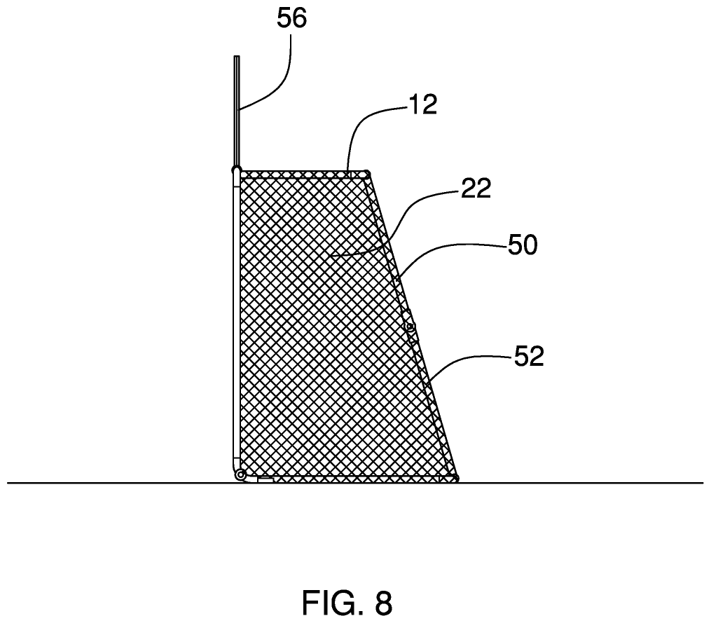

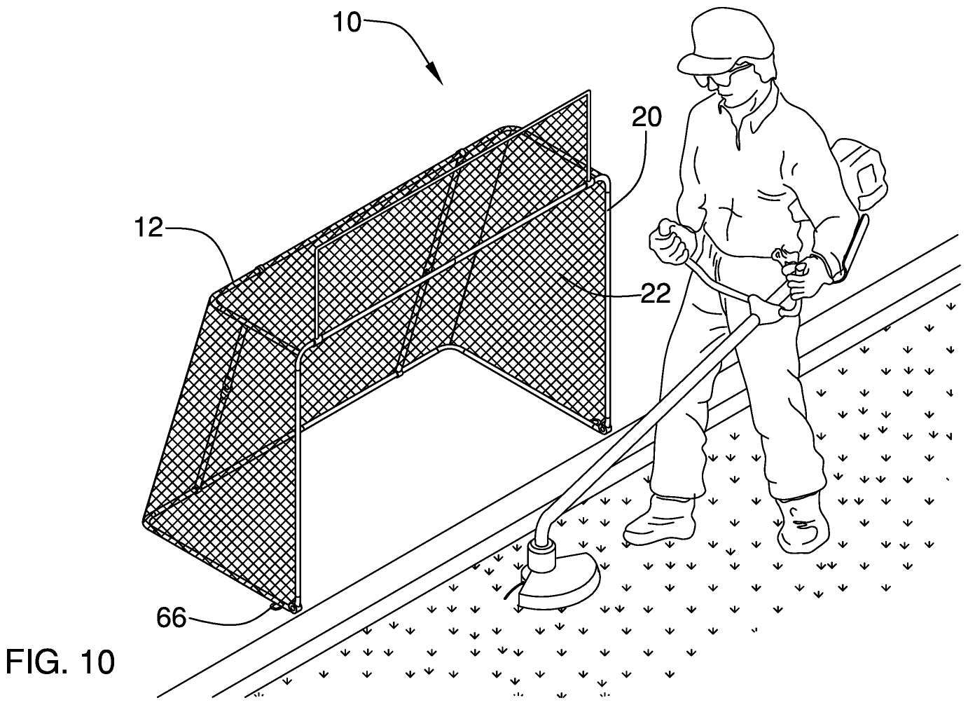

With reference now to the drawings, and in particular to FIGS. 1 through 10 thereof, a new trapping device embodying the principles and concepts of an embodiment of the disclosure and generally designated by the reference numeral 10 will be described.

As best illustrated in FIGS. 1 through 10, the projectile trapping device 10 generally comprises a shell 12, which defines an interior space 14. The shell 12 has a front face 16 and lower face 18, which are open. The shell 12 is configured to be positioned on a substantially horizontal surface between an object, such as a vehicle, a person, or glass, and a source of projectiles, such as those generated by a lawnmower, an edger, or a trimmer. The shell 12 is configured to prevent projectiles, such as rocks and debris propelled from the source, from striking the object.

The shell 12 comprises a frame 20 and a primary panel 22. The primary panel 22 is engaged to the frame 20 defining a top face 24, a rear face 26, and opposed side faces 28 of the shell 12. The primary panel 22 comprises mesh. The primary panel 22 and the frame 20 comprises plastic.

The frame 20 comprises a top member 30, a bottom member 32, and a plurality of uprights 34. Each upright 34 is engaged to and extends between the top member 30 and the bottom member 32 so that the top member 30 is substantially parallel to the bottom member 32. The top member 30 comprises a rear bar 36, a front bar 38, and a pair of side bars 40. Each side bar 40 is engaged to and extends between the rear bar 36 and the front bar 38 so that the top member 30 is substantially rectangularly shaped. The front bar 38 has opposed ends 42, each of which has a respective upright 34 engaged thereto and extending therefrom.

The bottom member 32 comprises a rear rod 44 and a pair of side rods 46. Each side rod 46 is engaged to and extends between the rear bar 36 and a respective upright 34. The side bars 40 may be dimensionally shorter than the side rods 46 so that the bottom member 32 is circumferentially larger than the top member 30. The present invention also anticipates the side bars 40 being dimensionally equivalent to the side rods 46. Each of the rear bar 36, the front bar 38, and the rear rod 44 comprises a plurality of nested sections 68 so that the frame 20 is selectively extensible.

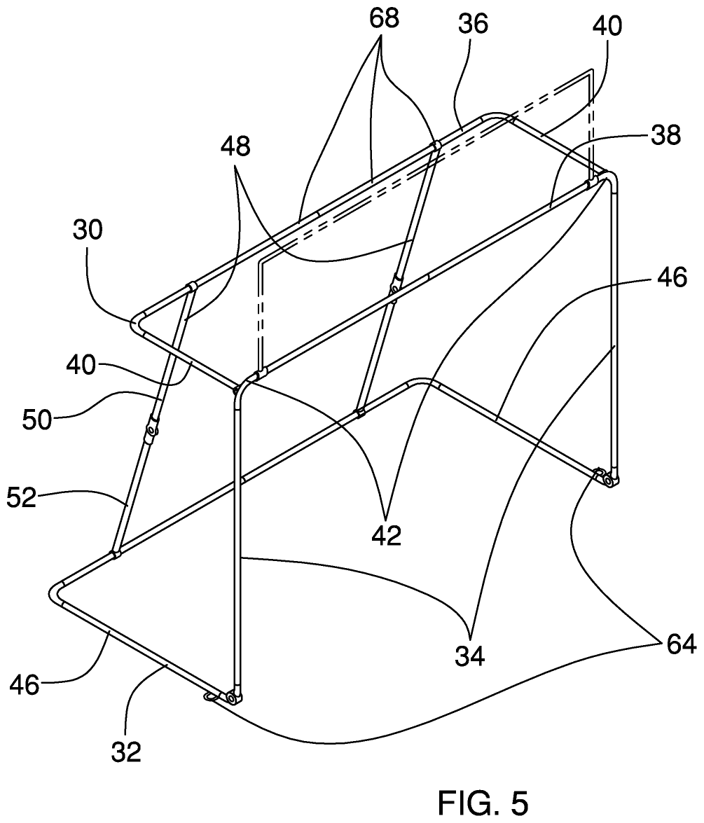

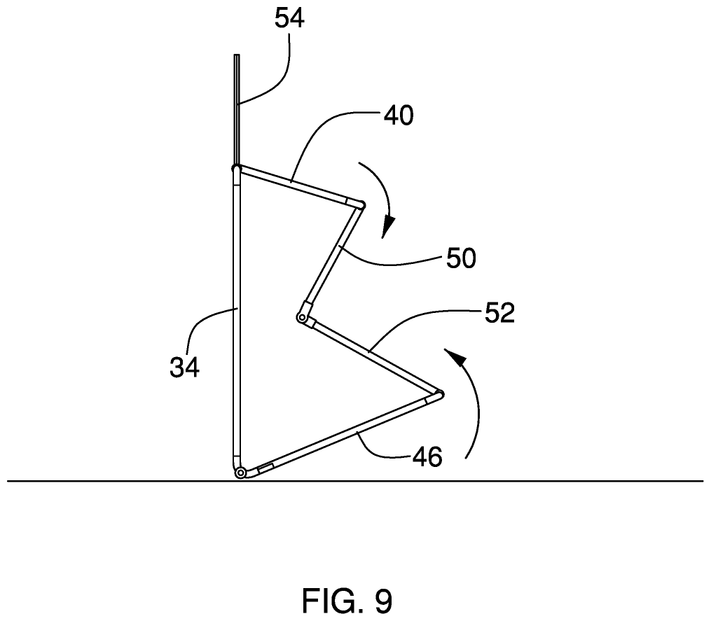

In another embodiment, as shown in FIGS. 5-10, the side bar 40 is hingedly engaged to the rear bar 36 and the front bar 38. The side rod 46 is hingedly engaged to the rear bar 36 and the respective upright 34. In this embodiment, each of a set of back rods 48 is hingedly engaged to and extends between the rear bar 36 and the rear rod 44. The back rod 48 comprises an upper section 50, which is hingedly engaged to a lower section 52, so that the frame 20 is selectively foldable, as shown in FIG. 9. The set of back rods 48 may comprise two back rods 48, as shown in FIG. 5, or other number of back rods 48, such as, but not limited to, one back rod 48, or three or more back rods 48.

A screen 54 is engaged to the shell 12 and extends upwardly therefrom so that the screen 54 is substantially coplanar with the front face 16. The screen 54 is configured to deflect projectiles propelled from the source toward the object. The screen 54 comprises a framework 56 having a secondary panel 58 engaged thereto. The framework 56 comprises a pair of end rods 60 and a top rod 62. Each end rod 60 is engaged to the top rod 62 and is slidably engaged to the top member 30 so that the screen 54 is substantially rectangularly shaped and so that the framework 56 is slidable relative to the frame 20.

A plurality of rings 64 is engaged to the bottom member 32. Each of a plurality of spikes 66 is selectively insertable through a respective ring 64 into a substrate, such as a lawn. The spike 66 is configured to fix the shell 12 to the substrate.

In use, the shell 12 is positioned between a person, pet, vehicle, glass door, glass window, or any other object that could be damaged, and an area from which projectiles might emanate, such as a lawn being mowed and trimmed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A projectile trapping device comprising a shell defining an interior space, the shell having a front face, the front face being open, wherein the shell is configured for positioning on a substantially horizontal surface between an object and a source of projectiles, wherein the shell is configured for preventing projectiles propelled from the source from striking the object.

2. The projectile trapping device of claim 1, wherein:
the shell has a lower face, the lower face being open; and
the shell comprises:
a frame comprising a top member, a bottom member, and a plurality of uprights, each upright being engaged to and extending between the top member and the bottom member such that the top member is substantially parallel to the bottom member; and
a primary panel engaged to the frame defining a top face, a rear face, and opposed side faces of the shell.

3. The projectile trapping device of claim 2, wherein:
the top member comprises a rear bar, a front bar, and a pair of side bars, each side bar being engaged to and extending between the rear bar and the front bar such that the top member is substantially rectangularly shaped, the front bar having opposed ends, each opposed end having a respective upright engaged thereto and extending therefrom; and
the bottom member comprises a rear rod and a pair of side rods, each side rod being engaged to and extending between the rear bar and a respective upright.

4. The projectile trapping device of claim 3, wherein the side bars are dimensionally shorter than the side rods, such that the bottom member is circumferentially larger than the top member.

5. The projectile trapping device of claim 3, wherein each of the rear bar, the front bar, and the rear rod comprises a plurality of nested sections, such that the frame is selectively extensible.

6. The projectile trapping device of claim 2, wherein the frame comprises plastic.

7. The projectile trapping device of claim 2, wherein the primary panel comprises mesh.

8. The projectile trapping device of claim 2, wherein the primary panel comprises plastic.

9. The projectile trapping device of claim 3, further including:
the side bar being hingedly engaged to the rear bar and the front bar, the side rod being hingedly engaged to the rear bar and the respective upright; and
a set of back rods, each back rod being hingedly engaged to and extending between the rear bar and the rear rod, the back rod comprising an upper section hingedly engaged to a lower section, such that the frame is selectively foldable.

10. The projectile trapping device of claim 9, wherein the set of back rods comprises two back rods.

11. The projectile trapping device of claim 1, further including a screen engaged to the shell and extending upwardly therefrom such that the screen is substantially coplanar with the front face, wherein the screen is configured for deflecting projectiles propelled from the source toward the object.

12. The projectile trapping device of claim 2, further including a screen engaged to the shell and extending upwardly therefrom such that the screen is substantially coplanar with the front face, the screen comprising a framework having a secondary panel engaged thereto, the framework comprising a pair of end rods and a top rod, each end rod being engaged to the top rod and slidably engaged to the top member, such that the screen is substantially rectangularly shaped and such that the framework is slidable relative to the frame, wherein the secondary panel is configured for deflecting projectiles propelled from the source toward the object.

13. The projectile trapping device of claim 2, further including:
a plurality of rings engaged to the bottom member; and
a plurality of spikes, each spike being selectively insertable through a respective ring into a substrate, wherein the spike is configured for fixing the shell to the substrate.

14. A projectile trapping device comprising:
a shell defining an interior space, the shell having a front face, the front face being open, the shell having a lower face, the lower face being open, wherein the shell is configured for positioning on a substantially horizontal surface between an object and a source of projectiles, wherein the shell is configured for preventing projectiles propelled from the source from striking the object, the shell comprising:
a frame comprising a top member, a bottom member, and a plurality of uprights, each upright being engaged to and extending between the top member and the bottom member such that the top member is substantially parallel to the bottom member, the top member comprising a rear bar, a front bar, and a pair of side bars, each side bar being engaged to and extending between the rear bar and the front bar such that the top member is substantially rectangularly shaped, the front bar having opposed ends, each opposed end having a respective upright engaged thereto and extending therefrom, the bottom member comprising a rear rod and a pair of side rods, each side rod being engaged to and extending between the rear bar and a respective upright, the side bars being dimensionally shorter than the side rods, such that the bottom member is circumferentially larger than the top member, each of the rear bar, the front bar, and the rear rod comprising a plurality of nested sections, such that the frame is selectively extensible, the frame comprising plastic, the side bar being hingedly engaged to the rear bar and the front bar, the side rod being hingedly engaged to the rear bar and the respective upright,
a set of back rods, each back rod being hingedly engaged to and extending between the rear bar and the rear rod, the back rod comprising an upper section hingedly engaged to a lower section, such that the frame is selectively foldable, the set of back rods comprising two back rods, and
a primary panel engaged to the frame defining a top face, a rear face, and opposed side faces of the shell, the primary panel comprising mesh, the primary panel comprising plastic;
a screen engaged to the shell and extending upwardly therefrom such that the screen is substantially coplanar with the front face, wherein the screen is configured for deflecting projectiles propelled from the source toward the object, the screen comprising a framework having a secondary panel engaged thereto, the framework comprising a pair of end rods and a top rod, each end rod being engaged to the top rod and slidably engaged to the top member, such that the screen is substantially rectangularly shaped and such that the framework is slidable relative to the frame;
a plurality of rings engaged to the bottom member; and
a plurality of spikes, each spike being selectively insertable through a respective ring into a substrate, wherein the spike is configured for fixing the shell to the substrate.
